(19) United States
(12) Patent Application Publication
(10) Pub. No.: US 2008/0173332 A1
(43) Pub. Date: Jul. 24, 2008

(54) MANUAL SYSTEM FOR DREDGING HEAVY TURNING PIPELINE

(76) Inventor: Jiayi ZHANG, Shenzhen (CN)

Correspondence Address: MATTHIAS SCHOLL, 14781 MEMORIAL DRIVE, SUITE 1319, HOUSTON, TX, 77079, US

(21) Appl. No.: 12/051,005

(22) Filed: Mar. 19, 2008

Related U.S. Application Data
(63) Continuation of application No. PCT/CN2005/001505, filed on Sep. 19, 2005.

(51) Int. Cl. B08B 9/027

(52) U.S. Cl. 134/22.11

(57) ABSTRACT

Provided is a manual system for dredging a heavy-turning pipeline, comprising a pipeline dredger and a water-pressure dredge pipe comprising a rocker and a spring-type dredge pipe connected thereto; wherein a spring-type dredge bit is disposed on an end of the spring-type dredge pipe; the water-pressure dredge pipe is a hollow hose having an back end that may be inserted into a pipeline to be dredged; and a cross section of the dredge bit has a cog or a sharp corner. In a process of dredging a pipeline, the cog or the sharp corner may easily winds blocking objects, so that it is possible to quickly dredge the pipeline and improve dredging efficiency. Furthermore, since an opening having a diameter less than the water-pressure dredge pipe is disposed at an end of the water-pressure dredge pipe, water column with higher pressure may be formed, and sprayed water column has enhanced scouring force. In addition, since openings with different spraying directions are used, the end of the water-pressure dredge pipe is capable of spraying at different angles, and thus dredging efficiency is improved.

### CROSS-REFERENCE TO RELATED APPLICATIONS

This application is a continuation of International Patent Application No. PCT/CN2005/001505 with an international filing date of Sep. 19, 2005, designating the United States, now pending, the contents of which are incorporated herein by reference.

### BACKGROUND OF THE INVENTION

1. Field of the Invention

The invention relates to a system for dredging a pipeline, and particularly to a manual system for dredging a heavy-turning pipeline that is suitable for dredging pipelines such as a sewerage and so on.

2. Description of the Related Art

In daily lives, sewerages are often blocked by various domestic refuses, particularly, as a pipeline of a sewerage is very slim and curved, dredging must be done by tools. In the prior art, there are different kinds of dredging tools, such as an electric dredger. The electric dredger is expensive, large and not suitable for family use. Moreover, it is inconvenient to request for door-to-door service of the electric dredger during sewerage blockage, and difficult to dredge blockage at heavy turning pipelines. To solve this problem, the inventor made a manual dredging tool and obtains patent with a patent number 00117566.1 and a name “MANUAL SYSTEM FOR DREDGING HEAVY TURNING PIPELINE”, and the patent has good market and technical effect. The invention comprises a pipeline dredger and a water-pressure dredge pipe, the pipeline dredger comprises a rocker and a spring-type dredge pipe connected thereto, a spring-type dredge bit is disposed on an end of the spring-type dredge pipe, the water-pressure dredge pipe is a hollow hose having an back end that may be inserted into a pipeline to be dredged. During use, the pipeline dredger and the water-pressure dredge pipe operate alternatively, and may effectively dredge blockage at heavy turning pipelines. However, since the spring-type dredge bit is circular and difficult to wind blocking objects. Moreover, an opening on an end of the water-pressure dredge pipe is consistent with the hose, high pressure is easily formed. In addition, an impulsive force has only one direction and it is difficult to improve a dredging effect.

To summarize, it is required to develop a system for dredging a heavy-turning pipeline which has better dredge effect.

### SUMMARY OF THE INVENTION

In view of the disadvantages in the prior art, one objective of the invention is to provide a system for dredging a heavy-turning pipeline, which is capable of effectively winding blocking objects and improving dredging efficiency, making it possible for higher pressure to be formed in an end of a water-pressure dredge so as to enable sprayed water column to have an enhanced scouring force, and for the end to spray at different angles so as to improve dredging efficiency.

To achieve the above objectives, in accordance with one embodiment of the invention, provided is a manual system for dredging a heavy-turning pipeline, comprising a pipeline dredger comprising a rocker and a spring-type dredge pipe connected thereto and a water-pressure dredge pipe; wherein a spring-type dredge bit is disposed on an end of the spring-type dredge pipe; the water-pressure dredge pipe is a hollow hose having an back end that may be inserted into a pipeline to be dredged; and a cross section of the dredge bit has a cog or a sharp corner.

In certain classes of this embodiment, a cross section of the dredge bit is triangle, quadrilateral or quincuncial.

In certain classes of this embodiment, a hollow opening having a diameter less than the water-pressure dredge pipe is disposed at the end of the water-pressure dredge pipe.

In certain classes of this embodiment, the opening comprises at least two holes with different spraying directions.

In certain classes of this embodiment, the opening comprises a front hole spraying forwards, a sidefront hole spraying to a sidefront, and a sideback hole spraying to a sideback.

In certain classes of this embodiment, the rocker is curved to a Z shape; a hand-handling pipe and a hand-shaking pipe are fit on the rocker; a nut is disposed on one end of the rocker; a pair of caps are disposed on both ends of the hand-handling pipe; and a blade is disposed on the dredge pipe in the vicinity of the rocker.

In certain classes of this embodiment, the dredge pipe and the dredge bit are made of tight spring wound by carbon steel wires; a pitch of thread of the dredge pipe is h; a pitch of thread of the dredge bit is h1; and h1 is larger than h.

In certain classes of this embodiment, a length of the dredge bit is 200 mm; a length of a connection part between the dredge bit and the dredge pipe is 100 mm, and a pitch of thread therebetween increases in turn; and a pitch of thread of a remaining 100 mm is constant.

In certain classes of this embodiment, a diameter of the carbon steel wire is 1.8 mm; and a cross-sectional diameter of a spring of each of the dredge pipe and the dredge bit is 6 mm.

Compared with the prior art, a manual system for dredging a heavy-turning pipeline of the invention employs a cog or a sharp corner on a cross section of the dredge bit, in a process of dredging a pipeline, the cog or the sharp corner may easily winds blocking objects, so that it is possible to quickly dredge the pipeline and improve dredging efficiency. Furthermore, since a hollow opening having a diameter less than the water-pressure dredge pipe is disposed at an end of the water-pressure dredge pipe, water column with higher pressure may be formed, and sprayed water column has enhanced scouring force. In addition, since openings with different spraying directions are used, the end of the water-pressure dredge pipe is capable of spraying at different angles, and thus dredging efficiency is improved.

### BRIEF DESCRIPTION OF THE DRAWINGS

FIG. 1 is a schematic diagram of a manual system for dredging a heavy-turning pipeline of the invention;

FIG. 2 is a schematic diagram of a water-pressure dredge pipe; and

FIG. 3 is an axial cross-sectional view of the end of a water-pressure dredge pipe.

### DETAILED DESCRIPTION OF THE INVENTION

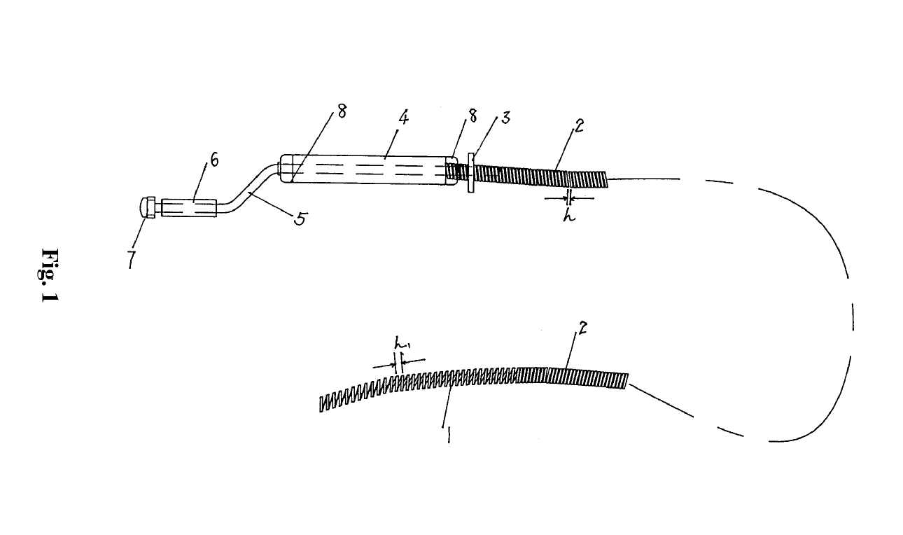

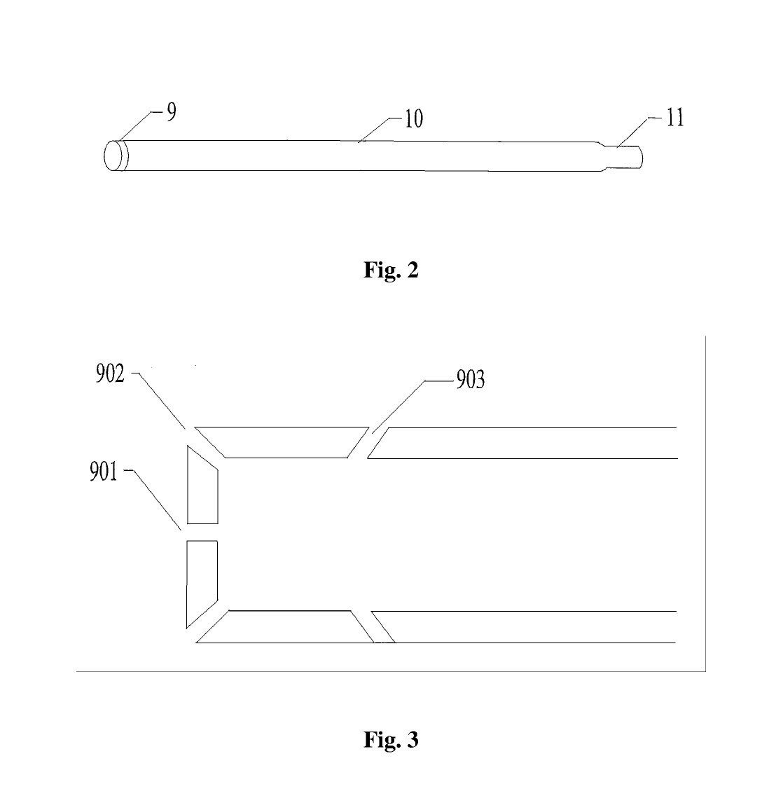

As shown in FIGS. 1 and 2, a manual system for dredging a heavy-turning pipeline comprises a pipeline dredger and a water-pressure dredge pipe. As shown in FIG. 1, the pipeline dredger comprises a rocker 5 and a spring-type dredge pipe 2 connected to the rocker 5, a dredge bit 1 having a triangle cross section is disposed on an end of the spring-type dredge pipe 2, the rocker 5 is curved to a Z shape, a hand-handling pipe 4 and a hand-shaking pipe 6 are fit on the rocker 5, a nut 7 is disposed on one end of the rocker 5, a pair of caps 8 are disposed on both ends of the hand-handling pipe 4, and a blade 3 is disposed on the dredge pipe 2 in the vicinity of the rocker 5; As shown in FIG. 2, the water-pressure dredge pipe is a hollow hose, and comprises a main body 10, an back end 11 that may be inserted into a pipeline to be dredged, and a front end 9 connected to a water source (such as a hydrant), a hollow opening having a diameter less than the water-pressure dredge pipe is disposed at an end of the water-pressure dredge pipe 11. As shown in FIG. 3, the above-mentioned opening comprises a front hole 901 spraying forwards, a sidefront hole 902 spraying to a sidefront, and a sideback hole 903 spraying to a sideback.

A cross section of the dredge bit 1 may be quadrilateral, quincuncial and so on, as long as a cross section of the dredge bit 1 has a cog or a sharp corner.

The number of openings of the back end 11 of the water-pressure dredge pipe, spraying directions and a diameter of the opening may be determined on request. For convenience, the back end 11 of the water-pressure dredge pipe may be set to a demountable part, and is connected to the main body 10 via mechanical joint or thread connection, so that a back end 11 with different structure (such as different number of openings, spraying directions and diameters of the opening) is implemented to meet various requirements.

In the above-mentioned system, the dredge pipe 2 and the dredge bit 1 are made of tight spring wound by carbon steel wires, a pitch of thread of the dredge pipe 2 is h, a pitch of thread of the dredge bit 1 is h1, and h1 is larger than h. A length of the dredge bit 1 is 200 mm, in which a length of a connection part between the dredge bit 1 and the dredge pipe 2 is 100 mm and a pitch of thread therebetween increases in turn, a pitch of thread of a remaining 100 mm is constant. A diameter of the carbon steel wire is 1.8 mm, and a cross-sectional diameter of a spring of each of the dredge pipe 2 and the dredge bit 1 is 6 mm.

Operation method, in the above-mentioned dredging system, the pipeline dredger is a main part, and the water-pressure dredge pipe is an auxiliary, three operation methods will be described in detail below.

Operation method 1—one man operation method, the bit 1 and the dredge pipe 2 of the pipeline dredger are directly inserted into a place of a pipeline where blocking occurs, using one hand to hold the hand-handling pipe 4 and another hand to hold the hand-shaking pipe 6, and pulling the dredge pipe 2 up and down by combining main clockwise shaking with auxiliary anticlockwise shaking. Since the dredge bit 1 is soft than the dredge pipe 2, so that it can easily pass a heavy-turning portion of a pipeline. The above process is repeated until dredging is completed, during this period, the dredge bit 1 and the dredge pipe 2 may effectively wind cloth, thread, hair and other blocking objects and clear them, the dredge bit 1 is also capable of pushing hard objects into a main path.

Operation method 2—two men operation method, the bit 1 and the dredge pipe 2 of the pipeline dredger are directly inserted into a place of a pipeline where blocking occurs, one man holds an upfront end of the dredge pipe 2 and guides another one to dredge, another one uses one hand to hold the hand-handling pipe 4 and another hand to hold the hand-shaking pipe 6, and combines main clockwise shaking with auxiliary anticlockwise shaking until dredging is completed.

Operation method 3—using a water-pressure dredge pipe, as the back end 11 only has a front hole spraying forwards, the front end 9 is tightly connected to a hydrant, the back end 11 is inserted into a pipeline to be dredged for 100 mm, an opening of the pipeline is sealed, the hydrant is opened and automatic dredging is performed via water pressure. As water washes, blocking objects are inserted into the back end 11 of the water-pressure dredge pipe, then high pressure water column with different spraying directions washes the blocking objects, so as to dredge a pipeline.

What is claimed is:

1. A manual system for dredging a heavy-turning pipeline, comprising
a pipeline dredger comprising a rocker (5) and a spring-type dredge pipe (2) connected thereto; and
a water-pressure dredge pipe;
wherein
a spring-type dredge bit (1) is disposed on an end of said spring-type dredge pipe (2);
said water-pressure dredge pipe is a hollow hose having an back end (11) that may be inserted into a pipeline to be dredged; and
a cross section of said dredge bit (1) has a cog or a sharp corner.

2. The manual system for dredging a heavy-turning pipeline of claim 1, wherein a cross section of said dredge bit (1) is triangle, quadrilateral or quincuncial.

3. The manual system for dredging a heavy-turning pipeline of claim 1, wherein a hollow opening having a diameter less than said water-pressure dredge pipe is disposed at said back end (11) of said water-pressure dredge pipe.

4. The manual system for dredging a heavy-turning pipeline of claim 3, wherein said opening comprises at least two holes with different spraying directions.

5. The manual system for dredging a heavy-turning pipeline of claim 4, wherein said opening comprises a front hole (901) spraying forwards, a sidefront hole (902) spraying to a sidefront, and a sideback hole (903) spraying to a sideback.

6. The manual system for dredging a heavy-turning pipeline of any one of claims 1-5, wherein
said rocker (5) is curved to a Z shape;
a hand-handling pipe (4) and a hand-shaking pipe (6) are fit on said rocker (5);
a nut (7) is disposed at the end of said rocker (5);
a pair of caps (8) are disposed on both ends of said hand-handling pipe (4); and
a blade (3) is disposed on said dredge pipe (2) in the vicinity of said rocker (5).

7. The manual system for dredging a heavy-turning pipeline of claim 1, wherein
said dredge pipe (2) and said dredge bit (1) are made of tight spring wound by carbon steel wires;
a pitch of thread of said dredge pipe (2) is h;
a pitch of thread of said dredge bit (1) is h1; and
h1 is larger than h.

8. The manual system for dredging a heavy-turning pipeline of claim 7, wherein
a length of said dredge bit (1) is 200 mm;
a length of a connection part between said dredge bit (1) and said dredge pipe (2) is 100 mm, and a pitch of thread therebetween increases in turn; and
a pitch of thread of a remaining 100 mm is constant.

9. The manual system for dredging a heavy-turning pipeline of claim 7, wherein
a diameter of said carbon steel wire is 1.8 mm; and
a cross-sectional diameter of a spring of each of said dredge pipe (2) and said dredge bit (1) is 6 mm.
